(19) United States
(12) Patent Application Publication
(10) Pub. No.: US 2017/0305579 A1
(43) Pub. Date: Oct. 26, 2017

(54) POWER ARCHITECTURE FOR SOLAR ELECTRIC PROPULSION APPLICATIONS

(71) Applicant: Aerojet Rocketdyne, Inc., Sacramento, CA (US)

(72) Inventor: Cheng-Yi Lu, West Hills, CA (US)

(21) Appl. No.: 15/518,161

(22) PCT Filed: Jul. 15, 2015
(86) PCT No.: PCT/US15/40548

§ 371 Date: Apr. 10, 2017

Related U.S. Application Data
(60) Provisional application No. 62/079,022, filed on Nov. 13, 2014.

(51) Int. Cl. B64G 1/40; B64G 1/42; B64G 1/44

(52) U.S. Cl. CPC B64G 1/406; B64G 1/44; B64G 1/405; B64G 1/428

(57) ABSTRACT

Systems and methods for powering an electrical thruster (112) of a vehicle (100). The methods comprise providing an unregulated high voltage output current of a high voltage solar array (122) directly to an electric propulsion system (104) of the vehicle. The electric propulsion system generates a converted high voltage current by converting a voltage level of the unregulated high voltage output current. The converted high voltage current is supplied directly to an anode of the electrical thruster. A regulated low voltage current is also generated by regulating a low voltage output of a low voltage solar array (124). The regulated low voltage current is used to supply power to at least one electronic component of the electrical thruster.

### CROSS-REFERENCE TO RELATED APPLICATION

This application claims the benefit and priority to U.S. provisional patent application Ser. No. 62/079,022 filed Nov. 13, 2014, the contents of which are incorporated herein by reference.

### BACKGROUND

### Statement of the Technical Field

The disclosure relates generally to Solar Electric Propulsion (“SEP”) power systems. More particularly, the disclosure relates to a power architecture for SEP applications.

### Description of the Related Art

Typically in a satellite or spacecraft, power flows from one or more power sources to a Power Management and Distribution (“PMAD”) system. The power sources can include, but are not limited to, batteries, fuel cells, and/or solar arrays of SEP systems. From there, the power is distributed to all loads. The loads include, but are not limited to, bus loads, payloads and an EP system. The PMAD system includes a collection of circuits comprising filters, distributors, converters, isolation circuits and regulators. During operation, the PMAD system outputs a regulated bus voltage that is distributed throughout the bus to the EP system, bus loads, payloads, and battery chargers. The bus loads include, but are not limited to, vehicle communication, guidance, navigation and control.

### SUMMARY OF THE INVENTION

This disclosure concerns methods for powering (by a power architecture) an electrical thruster of a vehicle. The methods involve providing an unregulated high voltage output current of a high voltage solar array directly to an electric propulsion system of the vehicle. The electric propulsion system generates a converted high voltage current by converting a voltage level of the unregulated high voltage output current. The converted high voltage current is supplied directly to an anode of the electrical thruster. A regulated low voltage current is also generated by regulating a low voltage output of a low voltage solar array. The regulated low voltage current is used to supply power to at least one electronic component of the electrical thruster.

In some scenarios, operations of an anode discharge converter of the electronic propulsion system are controlled such that the input voltage value from the high voltage solar array is always greater than or equal to the voltage value of a tracked peak power point of the high voltage solar array. Additionally or alternatively, a valve of the electronic propulsion system is controlled based on a tracked peak power point of the high voltage solar array.

The present discloses also concerns systems for powering an electrical thruster of a vehicle. Each system comprises an electric propulsion system and a high voltage solar array providing an unregulated high voltage output current to the electric propulsion system. The electric propulsion system generates a converted high voltage current by converting a voltage level of the unregulated high voltage output current. The converted high voltage current is supplied directly to an electrical thruster.

In some scenarios, the system also includes a power management and distribution system. The power management and distribution system generates a regulated low voltage current by regulating a low voltage output of a low voltage solar array. The regulated low voltage current is used to supply power to at least one electronic component of the electrical thruster. Operations of an anode discharge converter of the electronic propulsion system are controlled such that the input voltage value from the high voltage solar array is always greater than or equal to the voltage value of a tracked peak power point of the high voltage solar array. A valve of the electronic propulsion system is controlled based on a tracked peak power point of the high voltage solar array.

### BRIEF DESCRIPTION OF THE DRAWINGS

Embodiments will be described with reference to the following drawing.

FIG. 1 is a schematic illustration of an exemplary architecture for a vehicle.

FIGS. 2A through 2B (collectively referred to as “FIG. 2”) provide a flow diagram of an exemplary method for powering components of an electric propulsion system in non-eclipse and eclipse scenarios.

### DETAILED DESCRIPTION

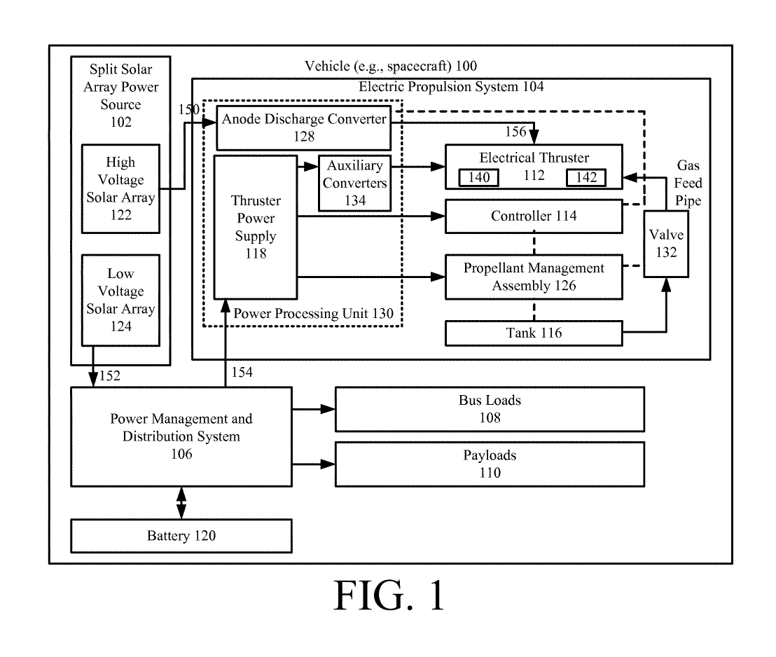

As shown in FIG. 1, the disclosure includes an SEP system for a vehicle 100. The vehicle 100 can include, but is not limited to, a spacecraft or a satellite. The SEP system may reduce the vehicle's parasitic power by more than 40%, thermal generation by more than 40%, mass and volume by approximately 22%, and cost by approximately 20% as compared to that of a conventional vehicle's SEP system.

During operation in non-eclipse scenarios, power flows from one or more power sources 102, 120 to a Power Management and Distribution (“PMAD”) system 106. The power sources may include a battery 120, a fuel cell (not shown), and/or solar arrays 122, 124. The PMAD system 106 distributes the power to loads 104, 108, 110 of the vehicle 100. In this regard, the PMAD system 106 includes a collection of circuits comprising filters, distributors, converters, isolation circuits and/or regulators. The circuits are arranged to output a regulated bus voltage that is distributed throughout the bus to the loads, as well as battery chargers (not shown). The loads may include bus loads 108, payloads 110 and an EP system 104. The bus loads 108 may include vehicle communication, guidance, navigation and control.

The EP system 104 comprises an electrical thruster 112 and a Power Processing Unit (“PPU”) 130. Electrical thrusters are well known in the art, and therefore will not be described in detail herein. In some scenarios, the electrical thruster includes, but is not limited to, a plasma based electrical thruster, an Ion thruster or a Hall Effect thruster. Although a single electrical thruster is shown in FIG. 1, the EP system is not so limited. Any number of electrical thrusters can be employed in accordance with a particular application.

Power may be supplied to the electrical thruster 112 by the SEP system of the vehicle 100 so as to turn it “on” and “off”, and so as to ensure that the electrical thruster 112 operates at operation needs with the maximum efficiency. In this regard, the SEP system comprises a Split Solar Array (“SSA”) power source 102, the PMAD 106, the PPU system 130, and a controller 114. The SSA power source 102 includes a High Voltage (“HV”) solar array 122 and a Low Voltage (“LV”) solar array 124. Solar arrays are well known in the art, and therefore will not be described in detail herein. Any known or to be known solar array can be used herein without limitation. For example, in some scenarios, each solar array 122, 124 comprises PhotoVoltaic (“PV”) modules electrically connected to each other and mounted on a supporting structure.

During operation, an LV output of the LV solar array 124 (e.g., 28 V) of the SSA power source 102 is provided to the PMAD system 106, including battery charging, in non-eclipse scenarios (as shown by reference number 152). In eclipse scenarios, an LV output of a battery 120 is provided to the PMAD system 106. At the PMAD system 106, the LV output of the LV solar array 124 and/or battery 120 is regulated. The regulated voltage output from the PMAD system 106 is then distributed to the thruster power supply 118 of the EP system 104, as shown by reference number 154.

In turn, the thruster power supply 118 provides an LV current to auxiliary converters 134. The auxiliary converters 134 use the LV current to supply power to at least one electronic component 142 of the electrical thruster 112. The electronic component(s) include(s), but is (are) not limited to, an internal magnet, an external magnet, an igniter/feeder and/or heaters.

At the time of firing of the electrical thruster 112 via the igniter/feeder, the electrical thruster 112 is supplied the propellant which is stored in tank 116. Accordingly, the EP system 104 also comprises at least one valve 132 for facilitating the precisely controlled provision of propellant to the electrical thruster 112. The valve 132 includes, but is not limited to, an electromechanical valve (e.g., a solenoid valve). The opening and closing of the valve 132 is precisely controlled by the controller 114 based on a tracked peak power point of the HV solar array 122. As a result, maximum ionization of the propellant is achieved with maximum available HV solar array current at all non-eclipse times by the electrical thruster 112 for operation required specific impulse (Isp).

The term “tracked peak power point”, as used herein, refers to a maximum power that is generated by a solar array power source at given operating conditions (e.g., temperature of solar array and/or amount of solar radiation). The maximum power is tracked by PPU 130 and/or controller 114. In this regard, these components 114, 130 implement a Peak Power Tracking (“PPT”) algorithm. PPT algorithms are well known in the art, and therefore will not be described herein. Any known or to be known PPT algorithm can be used herein without limitation.

In some scenarios, the PPU 130 has HV unregulated input voltage ranges to accommodate solar array life, thermal and operations. Alternatively or additionally, the PPU 130 comprises a plurality of modular PPUs for High Power (“HP”) and HV analog discharge converter outputs by series and parallel connections.

Propellant ionization is facilitated by the supply of a converted HV current to an anode 140 of the electrical thruster 112, as shown by reference number 156. An unregulated HV current is supplied to an Anode Discharge Converter (“ADC”) 128 of the PPU 130. The ADC 128 has wide (2:1) input voltage ranges (e.g., 70 to 140 volts) and wide output voltage ranges (e.g., 150 to 800 volts). The input voltage (e.g., 100 Vat BOL) of the ADC 128 is supplied from the HV solar array 122 of the SSA power source 102, without any intermediary regulation or power conditioning operations as shown by reference number 150. The converted HV current output of the ADC 128 is controlled by controller 114 based on the tracked peak power point of the HV solar array 122. As such, operations of the ADC 128 are controlled such that the input voltage level thereof is always greater than or equal to the voltage value of tracked peak power point of the HV solar array 122.

As evident from the above discussion, a power architecture of the SEP system architecture is defined by components 102, 106, 112, 114, 120, 130. The power architecture balances between operation flexibility and design optimization, which has medium-to-maximum benefits on high power system efficiency, low thermal loads, high usage of power generated, low mass, volume, schedule and cost, while at the same time maintaining operation flexibility for various mission phases. Additionally, the power architecture frees the SEP system from dependence on a traditional regulated power bus and enables optimal performance by the electrical thruster 112. The electrical thruster 112 operates over a wide input voltage range from a dedicated HV power bus 150, while allowing other vehicle subsystems to use a dedicated LV power bus 154.

The operating point of the solar array HV channels are determined by the combined power demand of the electrical thruster 112. Most of the SEP mission will be operated in insolation, but the vehicle 100 may be in eclipse when the array temperature is as low as −160° C. (in a geosynchronous earth orbit). Even at this temperature, the designed HV solar array open circuit voltage can be lower than 140 volts (for 1 AU orbit). Because the PPU 130 is capable of operating over an input voltage range, the electrical thruster 112 would be activated as soon as the solar arrays 122, 124 entered insolation. Once the electrical thruster 112 is ignited, propellant flow would be ramped up to increase thruster power demand and drive the solar arrays 122, 124 to their peak power operating points. As the solar array operating point moves from its open circuit value of 140 volts to the peak power voltage of ˜70 volts, the PPU 130 and/or controller 114 would automatically increase the duty cycle of the input switches to maintain the desired output voltage.

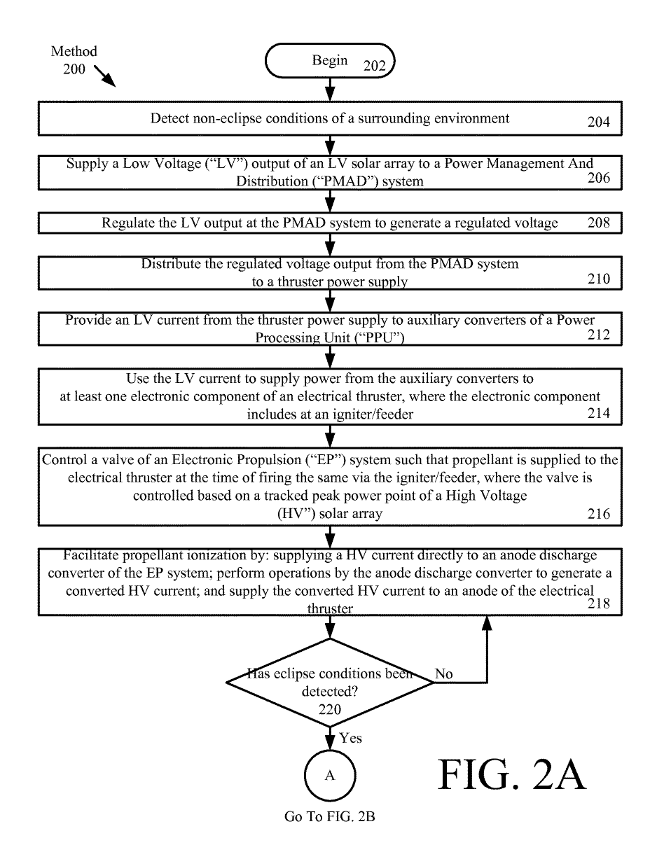

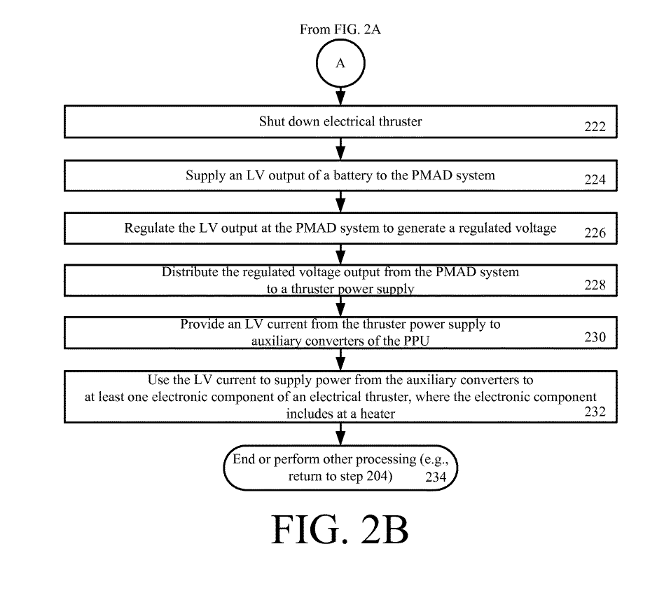

Referring now to FIGS. 2A-2B, there is provided a flow diagram of an exemplary method 200 for powering components of an EP system (e.g., an EP system 104 of FIG. 1) in non-eclipse and eclipse scenarios. A shown in FIG. 2A, the method 200 begin with step 202 and continue with step 204 where non-eclipse conditions of a surrounding environment are detected. Such detection can be made by measuring an increase in voltage by solar radiation and/or a decrease in power being generated by a solar array.

When such non-eclipse conditions are detected, steps 206-218 are performed for powering an electrical thruster (e.g., electrical thruster 112 of FIG. 1). Steps 206-216 involve: supplying an LV output of an LV solar array (e.g., LV solar array 124 of FIG. 1) to a PMAD system (e.g., PMAD 106 of FIG. 1); regulating the LV output at the PMAD system to generate a regulated voltage; distributing the regulated voltage output from the PMAD system to a thruster power supply (e.g., thruster power supply 118 of FIG. 1); providing an LV current from the thruster power supply to auxiliary converters (e.g., auxiliary converters 134 of FIG. 1) of a PPU (e.g., PPU 130 of FIG. 1); using the LV current to supply power from the auxiliary converters to at least an igniter/feeder (e.g., electronic component 142 of FIG. 1) of the electrical thruster; and controlling a valve (e.g.,. valve 132 of FIG. 1) of the EP system such that propellant is supplied to the electrical thruster at the time of firing via the igniter/feeder. The valve is controlled based on a tracked peak power point of an HV solar array (e.g., HV solar array 122 of FIG. 1). In step 218, propellant ionization is facilitate by: supplying an HV current directly to an anode discharge converter (e.g., anode discharge converter 128 of FIG. 1) of the EP system; performing operations by the anode discharge converter to generate a converted HV current; and supplying the converted HV current to an anode (e.g., anode 140 of FIG. 1) of the electrical thruster.

Notably, operations are periodically or continuously performed to detect non-eclipse and/or eclipse conditions of the surrounding environment. If eclipse conditions are not detected [220:N0], then method 200 returns to step 218. In contrast, if eclipse conditions are detected [220:YES], then method 200 continues to step 222-232 of FIG. 2B.

As shown in FIG. 2B, steps 222-232 involve: shutting down the electrical thruster; supplying an LV output of a battery (e.g., battery 120 of FIG. 1) to the PMAD system; regulating the LV output at the PMAD system to generate a regulated voltage; distributing the regulated voltage output from the PMAD system to a thruster power supply; providing an LV current from the thruster power supply to auxiliary converters of the PPU; and using the LV current to supply power from the auxiliary converters to at least a heater (e.g., heater 142 of FIG. 1) of the electrical thruster. Upon completing step 232, step 234 is performed where method 200 ends or other processing is performed (e.g., return to step 204 of FIG. 2A).

What is claimed is:

1. A method for powering an electrical thruster of a vehicle, comprising:
providing an unregulated High Voltage (“HV”) output current of an HV solar array directly to an Electric Propulsion (“EP”) system of the vehicle;
generating, by the EP system, a converted HV current by converting a voltage level of the unregulated HV output current; and
supplying the converted HV current directly to an anode of the electrical thruster.

2. The method according to claim 1, further comprising:
generating a regulated Low Voltage (“LV”) current by regulating an LV output of an LV solar array; and
using the regulated LV current to supply power to at least one electronic component of the electrical thruster.

3. The method according to claim 1, further comprising controlling operations of an anode discharge converter of the EP system such that an input voltage value from the HV solar array is always greater than or equal to a voltage value of a tracked peak power point of the HV solar array.

4. The method according to claim 1, further comprising controlling a valve of the EP system based on a tracked peak power point of the HV solar array.

5. A system, comprising:
an Electric Propulsion (“EP”) system; and
a High Voltage (“HV”) solar array providing an unregulated HV output current to the EP system;
wherein the EP system (1) generates a converted HV current by converting a voltage level of the unregulated HV output current, and (2) supplies the converted HV current directly to an electrical thruster.

6. The system according to claim 5, further comprising a Power Management and Distribution system generating a regulated Low Voltage (“LV”) current by regulating an LV output of an LV solar array.

7. The system according to claim 6, wherein the regulated LV current is used to supply power to at least one electronic component of the electrical thruster.

8. The system according to claim 5, wherein operations of an anode discharge converter of the EP system is controlled such that an input voltage value from the HV solar array is always greater than or equal to a voltage value of a tracked peak power point of the HV solar array.

9. The system according to claim 5, wherein a valve of the EP system is controlled based on a tracked peak power point of the HV solar array.
